(19) United States
(12) Patent Application Publication
(10) Pub. No.: US 2014/0379119 A1
(43) Pub. Date: Dec. 25, 2014

(54) SYSTEM FOR REMOTE AND AUTOMATED MANUFACTURE OF PRODUCTS FROM USER DATA

(71) Applicants: Maro Sciacchitano, McLean, VA (US); Tristan Renaud, Geneva (CH); Erik Ziegler, Liege (BE)

(72) Inventors: Maro Sciacchitano, McLean, VA (US); Tristan Renaud, Geneva (CH); Erik Ziegler, Liege (BE)

(21) Appl. No.: 13/922,677

(22) Filed: Jun. 20, 2013

(51) Int. Cl. G05B 19/4097

(52) U.S. Cl. CPC G05B 19/4097
USPC 700/182

(57) ABSTRACT

A system for Remote and Automated Manufacture of Products from User Data is designed to allow a user with no knowledge of design, engineering, or manufacturing to create a custom product from data they provide, in the form of tomography data, photographs, voice command, sketches etc. The system provides a user interface, the Front End, where users input data and select what to manufacture. This information is then sent to the Back End, which processes the data, creates a manufacturable 3D model, determines the best production method, and calculates a price and the amount of time required to make and deliver the product. This information is presented to the user, who confirms the proposal or makes changes the selection, materials etc, until they are happy with the result. Once they confirm their order, the system automatically produces the object and it is shipped to the user.

### BACKGROUND

Modern manufacturing processes can produce a huge array of different products from various materials at lower costs and more quickly that at any time in human history. The advent of widely available additive manufacturing processes, as well as the low cost of automation allows those with expertise in engineering and design to create prototypes, custom products and mass produced items cheaply and easily. However, for those without a large amount of specialized training and expertise, these modern technological innovations remain out of reach. Similarly, modern software and computing power has made it possible to convert a wide array of data into 3D digital models. For instance, it is now possible to use a series of photographs to reproduce the approximate shape of an object in a computer model. These processes are also largely available only at high cost to dedicated imaging, manufacturing and design professionals. Our invention addresses this issue by allowing non-experts to harness modern automated design and manufacturing tools, without training or experience.

### BRIEF SUMMARY OF THE INVENTION

An embodiment of the System for Remote and Automated Manufacture of Products from Imaging Data is a system consisting of a Front End software module, and Back End software module, and Manufacturing Facility. The Back End and Manufacturing Facility may be co-located, but the Front End can be remote, served by the Back End over a wired or wireless connection (e.g. the internet).

The Front End is the interface between the user and the system and allows the user to upload their data, pick the parts of the data they wish to manufacture and order the product. The Back End software handles all of the details, creates the 3D model for manufacture, checks it for problems, corrects any problems, suggests a manufacturing method based on the properties of the 3D model, calculates the size, weight, cost, and estimates the time to manufacture and deliver the product. It then relays these results to the user via the Front End, where the user decides to change the selection or purchase the model as presented.

The Back End then passes this information to the Manufacturing Facility which produces the product to the user's specifications. The product is then shipped to the user.

The process is entirely automated, so that the user need not input any design parameters in order to receive a product, but only needs the raw data to input into the system at the beginning. The user's data and inputs, once received by the Back End, are automatically converted into a manufacturable model. Once the user decides to manufacture the product, the manufacturing data is automatically dispatched to the manufacturing facility, where the designated manufacturing equipment is assigned to that production job and begins to make the product. The manufacturing methods used may include, but are not limited to, computer numerically controlled (CNC) milling, CNC lathing, CNC electron discharge machining (EDM), and 3D printing techniques such as stereolithography (SLA), fused deposition modeling (FDM), and other techniques. Additionally, the manufacturing process might include 2 or more steps, such as manufacturing a model by one of the above methods and then using a technique such as injection molding or casting to produce the final product.

Another embodiment places the Front End and Manufacturing Facility in the same physical location, but with the Back End located remotely. This allows data services to be consolidated for robustness, cost savings or convenience, while eliminating the time required for delivery of the product by manufacturing the products directly at the customer's location.

In a third embodiment the entire system may be co-located inside the same facility, with access to the Front End both through local devices and remote devices at other locations.

### BRIEF DESCRIPTION OF THE DRAWINGS

FIG. 1 shows the system as it would be used. A user inputs data via a remote device, which is then sent to the Back End where it is processed. The user inputs choices via the Front End and the results are sent to the Back End, where the product is manufactured and shipped.

FIG. 2 shows details of the software step show in FIG. 1, and its function. The basic steps from user input, extraction of relevant data, model repair, inspection, ordering and billing are illustrated.

FIG. 3 shows various physical implementations of the invention. The figure illustrates ways in which the physical hardware and user(s) can be distributed over a geographic range in order to illustrate different aspects of the inventions utility in different situations.

FIG. 4 shows various practical embodiments of the invention. Each example has been chosen to illustrate the utility and novelty of the invention and to illustrate explicitly how it would function in different applications and in different industries.

### DETAILED DESCRIPTION OF THE INVENTION

With respect to the accompanying Figure, examples of a system for remote and automated manufacture of products from imaging data, according to embodiments of the invention, are disclosed. For purposes of explanation numerous specific details are shown in the drawings and set forth in the detailed description that follows in order to provide a thorough understanding of embodiments of the invention. It will be apparent, however, that embodiments of the invention may be practiced without these specific details. In other instances well known structures and devices are schematically shown in order to simplify the drawing.

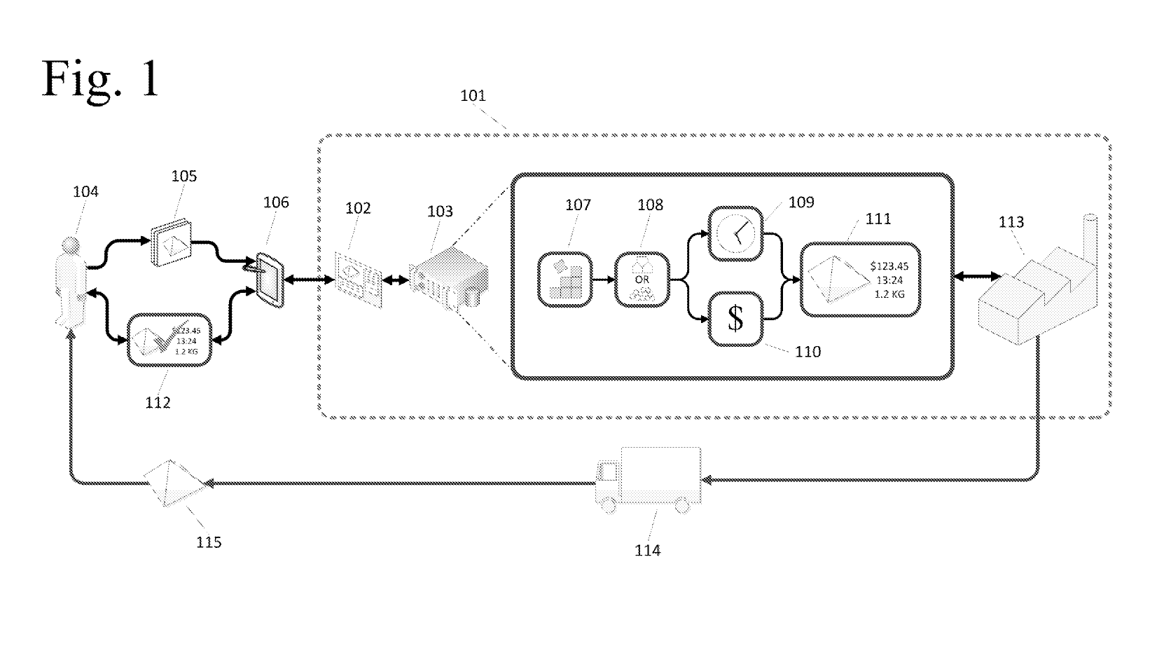

Shown in FIG. 1 an embodiment of the invention may be, but is not limited to a system 101 comprising a Front End 102 and a Back End 103. The Back End consists of a number of subcomponents and steps. The system also contains a means of automatically manufacturing 113 the products ordered.

The system 101 is initiated by a user 104 that uploads data 105 using an input device 106, a processor that may be, but not limited to a personal computer, mobile device or tablet computer. Via the Front End 102 the user chooses the parts of the data that they wish to produce. The data 105 may be, any type suitable for producing a manufacturing model, including tomography data such as magnetic resonance imaging (MRI), positron emission tomography (PET), or computed tomography (CT) scans, x-rays, photographs, sketches, or ultrasound data. Many types of data uploaded may be, (but not necessarily) inherently non-manufacturable in their raw state and would typically require many hours of labor to convert into a manufacturable form. The system is intended to allow users with no knowledge of computing, design, engineering or manufacturing to create a custom object from their own information.

In advanced embodiments of the invention “data” 105 could be entirely non-visual. For instance, a disabled person, who cannot use traditional input methods, may use voice commands to input design data. Natural language processing is currently capable of parsing spoken sentences and extracting key meanings. Linking these words to a database of primitives (basic design elements) and combining them with specific design rules would let the user create a product with entering any hard data.

The front end 102 designed to be operated by a user 104 who has no formal training or knowledge of manufacturing or design, but may be, but not necessarily an expert in another field where a custom tailored product would be highly useful, e.g. a doctor, craftsman or artist. The controls of the front end would typically be tuned to a specific profession, so that they can make inputs in a way that is familiar. For instance a doctor might use an interface that is very similar to an ordinary medical image viewing system, but lets them isolate the area of interest in the images and manufacture them. Similarly, an artist would be presented with an interface that follows the convention of photo editing software, allowing them to create the object they want in an intuitive environment. Even simpler, “one click” interfaces can be imagined, that use Back End 103 software to make educated guesses about the desired end result based on particular aspects of the input data. Such features may require machine learning methods to properly implement.

Once the user 104 uploads the data 105 it sent to the Back End 103 where it is used along with the users input to assemble 107 a model. The Back End then determines 108 what manufacturing method of those available and calculates the time 109 required to produce and deliver the model, a price 110 as well as the weight and size, and puts these together in a database entry 111. Automated determination of appropriate manufacturing technique typically takes into account not only the size of the model, but also the size of the features that are trying to be reproduced. A model with a large number of small, delicate features, may not be suitable for certain processes or may require special handling, and the software can determine what course of action to take automatically, or for instance, flag the order for special attention. In some cases of course, the user may specify a certain material or process specific to their need. Pricing is typically determined by the products final volume, combined with the amount of total material and energy required in production. Sometimes post-processing, such as baking, coating or curing may be required, in which case a special charge can be assessed. This information is then relayed back to the user via the Front End where they decide to either accept the product 112 or make further changes to via the Front End.

Once the user has approved of the product the Back End sends the manufacturing model from the database 111 to the manufacturing equipment 113 where the physical product 115 is manufactured according the user specifications, is shipped 114.

The need for robust, accurate reproduction of customer's data, the enormously diverse array of forms that can be extracted from such a wide variety imaging techniques, and the desire to introduce as much automation as possible into the process, additive manufacturing (3D printing) techniques are ideal for this type of process. Data can be sent to translation software specific to each 3D printer type and then directly to the printer, without almost any human intervention. In many cases, products manufactured using additive manufacturing processes, are more dimensionally accurate than products created using traditional manufacturing techniques.

However, this does not exclude more traditional types of manufacturing technologies, such as casting, machining and turning, from being used to create the customers product. In many cases, a combination of 3D printing and traditional manufacturing processes may be needed to ensure a high quality product. Additionally products may need to be sterilized, coated, polished, baked or otherwise post-processed in order to meet quality standards. These processes can also be automated and roboticized using standard, currently available industrial automation tools.

The original data sent by the user is, in general, inherently in a non-manufacturable state. Therefore a series of steps are required before a manufacturable model can be generated and inspected.

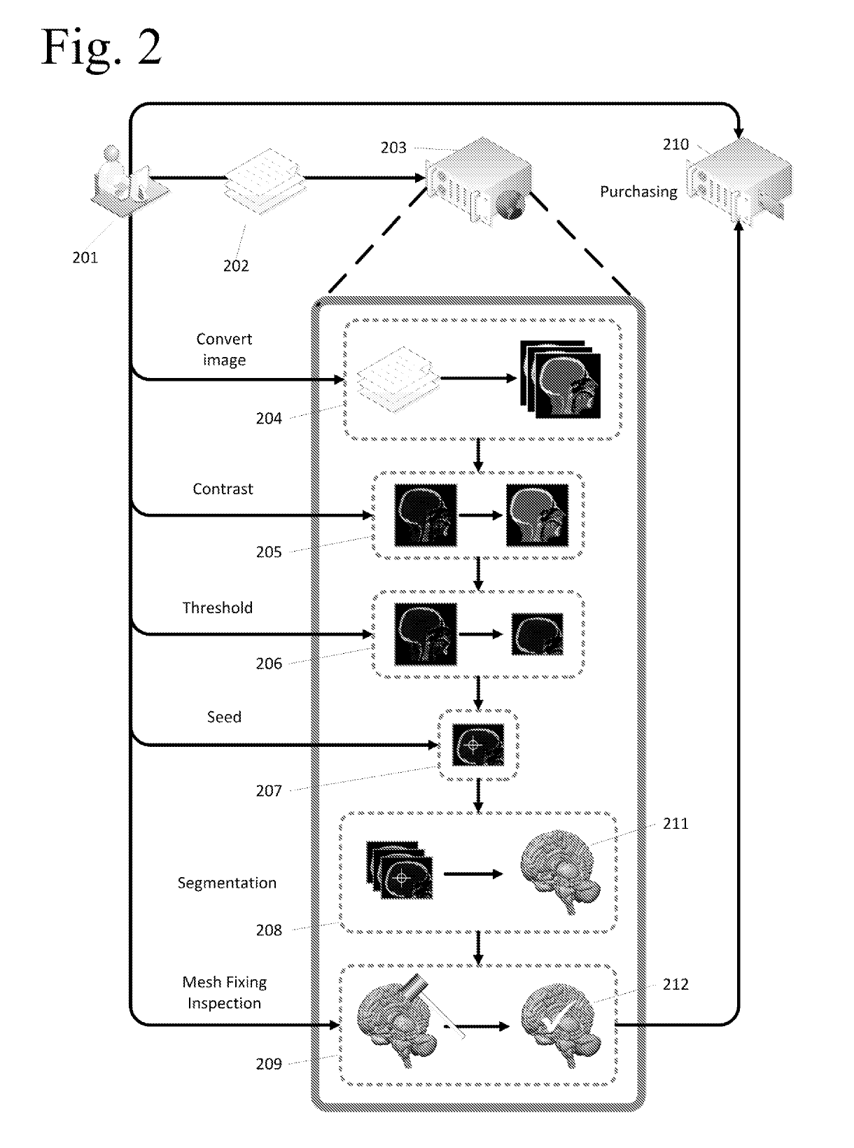

In FIG. 2 we see a diagram of the major steps involved in extracting manufacturable information from user data. This example shows one method, and is illustrative of the basic process, but there are many other specific methods for extracting the data of interest, depending on the user's needs and type of data provided.

The user 201 sends the data 202 to the server 203. The data 202 could contain multiple types of information. For example a single magnetic resonance imaging (MRI) sequence of a brain can be use by itself to create a 3D model. However, a structural scan of the brain can also be combined with a functional scan of the brain, and the two can be combined to create a model with far more information than either scan alone. One example would be to map blood flow correlations of the brain collected from a functional MRI with a precise structural scan to create a custom map of blood flow correlation in the patient. This is not limited to brains, or indeed biological systems. As another example, a fossil, preserved inside a rock, could be scanned by X-ray computed tomography (CT), and structural, density and compositional information can be obtained. The various data sets can then be combined in interesting ways, allowing the user to create multiple models of the same fossil, with density and mineral composition variously mapped on the surface in color. As an additional benefit, the fossil is not disturbed in the process, meaning any further advances in imaging techniques can be use in the future with a fully intact specimen.

The server converts 204 the data into a set of 2D and 3D images which can be viewed and manipulated over a remote connection.

The method of conversion is highly dependent on the type of data initially input. For instance, MRI tomography data that is originally stored in a frequency and phase space—k-space—has to be converted to spatial information via a Fourier transformation. CT data would require a Radon transformation. Photographic information may require a totally different approach.

Once the data has been put in a suitable format the user then optionally adjusts various image parameters like contrast and saturation 205 to optimize the visibility of the areas of interest in the image. If the image is color data, this may include changing multiple parameters or using different color pallets to improve visibility. In the case of vector data, which is complex to visualize, the user may opt to change the vector size or convert the vectors to a scalar magnitude or there, simpler, visualization. At this point the user would also choose any additional data included in the set to be combined as stated above. The software automatically takes care of handling any resolution or coordinate system mismatches between the datasets. A threshold 206 can be applied let the user highlight areas of the image that should be extracted by the software. The threshold is typically a scalar minimum and maximum value, say of densities that are of interest to the user. Thresholding could be expanded to include other data, for instance, in a dataset with multiple parameters, data could be placed on one parameter but executed on another. As an example, a scan could contain both chemical composition and density information. Various parameters can then be used such as AND OR, and XOR to extract only the volume that corresponds to the combined parameters. Thresholds can also be put on vector data, such as diffusion weighted MRI, so that only areas with certain directions, magnitudes, specific combinations of both, or vectors that fit certain parameters can be selected.

Alternately, or in parallel, a seed 207 can be placed in the image from which a sample is grown using specific parameters. These parameters could be a command to select all areas of a scan with similar properties, or all areas of a scan except those with certain properties. Parameters could be designed at allow certain types of shapes to be automatically extracted, or in the case of biological data, the software can be trained to locate extract certain anatomical features automatically based on data. Seeds can be used to specify a starting parameter, and then grow a volume from that point, or another point at a different location can be used to grow the volume of interest. Multiple seeds can be placed and could even use different grown parameters to create a single model. Growth parameters can vary but would include values such as the maximum acceptable deviation of neighboring voxels to be included based on the nominal value found at the original seed coordinate, A step parameter that determines how far away from the last positively identified voxel new voxels may be searched radially for similar values etc. The parameters may be, but not limited to, standardized values for certain categories of areas of interest, such as tumors, bones, or in industrial or academic settings, flaws in a casting, or specific mineral features in a fossil.

Using the parameters entered in the above steps, the software the goes through a process called segmentation 208 which extracts the relevant data according to the user's inputs and creates a 3D representation of that data 211.

Segmentation is simply creating a unified volume based on the voxels within the data set that meet the user's criteria. The reconstructed voxels are typically scalar values, and so represent a cube shaped volume in which there is only one value, be it a density, intensity, concentration. Because of this, at a certain point the model will have a rough appearance, since regardless of the true shape of the scanned object, it has been reduced, at some resolution, to a stack of cubes, and can be described as “pixilated”. Thus an optional smoothing algorithm can be applied which uses a local average value of surrounding local voxels to move the vertices of the model into a smoother and often more accurate surface. Often, in this process, additional vertices and polygons are created, and sometimes they are created in overabundance. This may require another process that simplifies the model to be run.

This process may be forgot altogether in favor of more automated processes, for instance the use of pattern recognition algorithms to identify invariant landmarks in the data. These are features which identify an object regardless of the scale at which the images or other data was taken. The template applied is created from training data which represents the type of objects that need to be extracted from the user data. The training extracts only the common features, e.g. if we are trying to identify bicycles, the training may ignore details like tassels and bells and focus on features that are universal such as handle bars and wheels. Techniques such as Scale-invariant Feature Transforms (SIFT) Geometric Hashing can then be applied to identify the features in specific data sets.

After the 3D data has been extracted, the model generated is then automatically checked for errors that would prevent manufacturing and repaired 209. This is a crucial step, and one that has been traditionally done manually. Because the data that is being used may come from virtually any source, and in particular from organisms which have complex and unusual shapes, the objects that result from the segmentation process can be extremely difficult to manufacture, even with modern additive processes. In order to reduce the amount of labor required to repair the digital model, and thus reduce cost and production time, the invention implements an automated system that can identify and automatically correct the vast majority of errors without the need for human intervention.

A typical manufacturing file could be in the stereolithography format, or a similar format. By no means is this meant to be an exhaustive discussion of file formats or error correction techniques. It is meant only as an illustrative example. Regardless of the format, the basic form of the data is a series of coordinates and vectors, which connect these points. These points, connected together, for a lattice of triangles and squares etc, which describes a surface. Typical errors that must be correct then, include points that are nearly or entirely on top of each other, points connected to nothing, or to too many or too few vertices. Additionally, the surface generated may initially suffer from non-manifoldness, meaning it may intersect itself or otherwise be non-physical. The model must also be watertight, or a closed surface, in order to be manufactured. In mathematical terms, the model must be a 2-manifold without boundary with shells that meet the same criteria, and satisfy the Euler-Poincaré formula. These types of errors and others can be extremely tedious to repair by hand, but new automated software techniques make it possible to repair almost all errors without compromising the overall shape of the product. The same software can also identify problematic features, which, while technically manufacturable, may be too delicate or otherwise poorly suited to the manufacturing technique initially specified. This allows corrective action to be taken before a failed attempt is made to create the customer's order.

The repaired model is finally inspected by the user to ensure that it is in fact the data the user would like to manufacture, at which point the model is approved 212 and sent to be purchased and manufactured 210.

In terms of physical implementations of the invention, there are several different configurations that have different advantages for the user and manufacturer. The primary advantage of the invention to the user is that they need neither expertise in manufacture nor the costly infrastructure, quality control or equipment needed to make complex, custom products. The manufacturer also can benefit because they can serve a large customer base from a single server, while using localized manufacturing to ensure prompt delivery and meet local production, labeling and shipping requirements more easily.

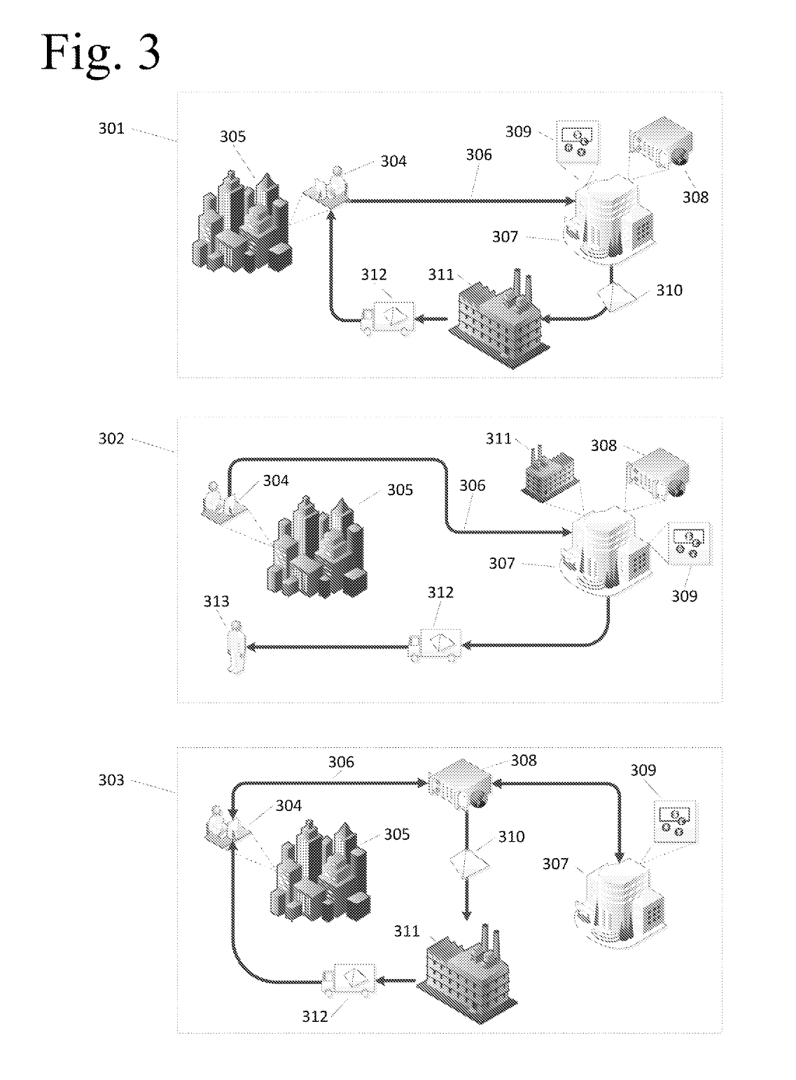

FIG. 3 has three diagrams that illustrate how various geographic implementations might work. 301 shows a scenario where the user 304, managing company 307 and manufacturing facility 311 are all located in separate places. In this scenario both servers 308 and the billing services 309 that let the collocated with the company's business operations. When the data is sent 306 by the user it is processed by the servers and manufacturing model generated 310 is sent directly to the manufacturing facility, where the product is created and the sent 312 directly to the user. In this case the user's location 305 may or may not be geographically close to either the company's servers or manufacturing facility.

Scenario two 302 shows a distinct advantage of the system, which is the ability to easily design, manufacture and drop-ship totally custom products to a third party. In this case, the servers 308, billing 309 and manufacturing 311 are all collocated at the company's facilities. When the user 304 orders the product 312 however it is shipped directly to a third party 313, who is the end user. This would be useful for instance, in diagnosing a complex illness, when the user has the ability to produce the data needed, but not the expertise to diagnose the illness or plan the surgery. The data is used to create a physical reproduction of the affected organ, and that is sent to an expert, who may be very far away, but who can diagnose or treat the illness via telesurgery or other methods.

The final scenario 303 illustrates a situation where the servers, company headquarters, and manufacturing facility are all located in physically different places, but work together though the manufacturing system to automatically generate custom products for the user. This may be practical when the user is located in a region 305 where the data security requirements vary enough to make transporting the raw user data across national boundaries unfeasible. Alternately there may be cost or security advantages to the company in housing the servers in remote locations. However the functionality of the invention remains the same, even though the components are distributed to optimize the user experience and minimize cost.

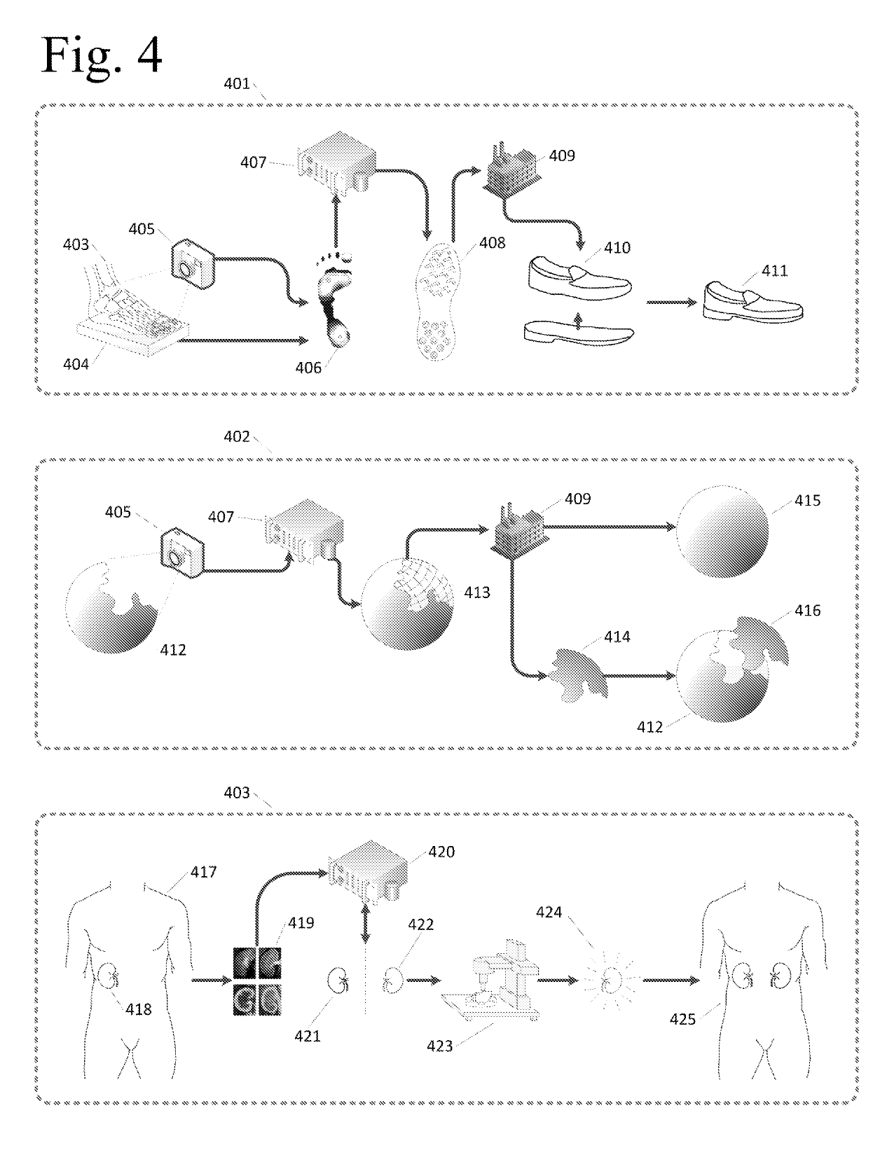

FIG. 4 shows 3 examples 401, 402, 403 of practical uses for the invention. These examples are of interest because they illustrate a particularly novel and advanced implementation of the invention. In this implementation, the data gathered and extracted during processing is used not to reproduce the imaged object, but to create new information, and a new object. The ability to create new information and new, useful devices from existing information automatically, without the use of design tools, extensive training or experience will expand access to production, manufacturing and custom products for many people.

In the first example 401 the system 407 and 408 are used to create a custom pair of shoes. In this case, the user may be a store clerk with no manufacturing knowledge, but the client is the shopper. The software component 407 is located remotely, but the manufacturing equipment 408 is located within the store. The clerk directs the customer to stand on a pressure sensor 404 which is collocated with an imaging device 405. The then clerk initiates the automated system.

The customer's feet 403 are measured and imaged. The “image” take could take the form of an ultrasonic contour of the feet, a visual image from multiple angles to reconstruct the shape, or simply a reference image taken from above. This information is used to recommend a fit for pre-manufactured components or to generate a customized shoe shape later in the process. Detailed information about the weight distribution of each foot can be gathered by the pressure sensor 404 which may have an array of many pressure sensitive devices in it. This array of sensors can reconstruct a precise map of the pressure on the bottom of the foot, and also measure the total weight of the individual. The pressure sensor also alters the operator to an excessive imbalance of weight distribution between the customer's feet, which could lead to errors in the manufacturing process.

The data 406 is compiled and sent to the back end, where the software generates a custom design appropriate to the customer's weight and physiology. Other inputs may also be used to refine the design, such as age, gender and height or the intended use of the shoe, casual, running, hiking, etc. The model of the custom designed footwear 408 is then sent back to the store, where the customer inspects the design and approves the purchase. The manufacturing equipment on site 409 creates the custom parts 410 of the shoe. In some cases, a stock design may be used for certain parts, and others, like the sole, may be custom, in other cases, all components may be entirely on-site. Finally, after assembly the finished shoe 411 is ready for sale. It is possible that with sufficiently advanced manufacturing techniques, the entire shoe can be manufactured without any further assembly required.

In an alternative approach to 401 the entire embodiment of the invention 406, 407 is located outside of the store. The customer may only use the store location as a place to have their feet imaged 404 and measured 403. The data can then be used to order multiple pairs of shoes using the internet. In this case the design 408 and assembly 409 of the shoe would be based on the same data 405, but would vary based on the style of shoe. For instance, an athletic shoe may require substantially different construction than a dress shoe, but both would use the client's data in order to compensate for suboptimal physiology, e.g. excessively high or low arches (pes planus or Pes cavus), uneven distribution of weight on the inside or outside (supination or pronation), or simply to enhance comfort for a client who has unusually but not abnormally shaped feet. The software 407 would contain a database of shoe style templates, each with a set of unique design rules. The design rules take the metrics gathered by the camera 405 and sensor 404, and any additional information, such as height and age, and adjust the design template to create a unique design for that particular customer.

In the cases of both online and in-store distribution the client's data 406 may be stored for a certain period of time to allow them to order more pairs of shoes over the time span of a few years. Eventually the data would expire and the client would be asked to return to the store to have their feet remeasured.

This method could be expanded to the automated manufacture of custom fitted clothing and accessories like glasses, hats, and gloves. Once the biophysical data is acquired, huge array of different ergonomic products, including furniture and beds can be manufactured exactly to order and on demand.

The second example 402 shows a system used to repair object that has been damaged. The object 412 that needs to be repaired could be an inanimate object or something biological. Examples of inanimate objects that might be repaired this way would be partial remains or artifacts discovered by archeologists or paleontologists, antiques, or an obsolete part that cannot be purchased anymore. The technique may also be used to treat patients. Damage to a bone or even soft tissue could be repaired by generating a replacement part for just the part that is damaged. Objects with strong symmetry, such as a vase or a skull, are particularly well suited to this process.

The object 412 that needs to be repaired is imaged 405 and the data is sent to the software back end 407. The software may use different techniques to reconstruct the missing parts of the object. In the case of an object with very well defined symmetry, like a vase, the software may be able to find the symmetry axis or plane very easily, or the software may request that the user define a symmetry plane by simply dragging a virtual plane through a virtual representation of the object of interest. In the case of some objects, like a bone, the software may have a database that includes a large number of example bones, and would use these to “learn” what the correct shape of a specific bone is. This would be repeated for different bones, both genders and for bones of different age. The user would need to identify exactly what anatomical feature or type of object they want to repair, and the software would then use the database and previously trained algorithms to determine how best to reconstruct the object.

Once the virtual reconstruction 413 is finished, it is displayed to the user, for approval. The user may want to change certain parameters, such as fit and finish. In the case of a repair, the user may want an interference fit and extra material on the surface, to ensure that when the object is repaired any seams are minimized. Or the part may need to come as close to finished as possible and fit loosely. Additionally, if there is a problem with the reconstruction, the user has the option to change qualitative parameters and any symmetry inputs and retry the process.

Once approved the reconstruction data 413 is sent to be manufactured 409. At this point, there are two possibilities. The first possibility is the one discussed above at length. A part 414 intended to repair the damaged object 412 is created and installed 416. The second option is to completely reproduce the damage object 412 as if it had never been damaged in the first place. This replica 415 would be very close to the original and could, in certain cases, use very similar materials. In order to mitigate the risk of forgery, markings, micro-printing, or imbedded, non-visible “watermarks” can be used. Authentic looking reproductions of antiques, fossils and many other valuable objects can be created ethically in this way. This second course of action would be useful when repairing the object 412 is impossible, risky or would degrade its value. It's also useful when a “working” copy of the object is desired, and the original cannot, for whatever reason, be used.

The third example 403 demonstrates a highly advanced application that has only recently become possible due to advances in biology and bioengineering; the reproduction of an entirely new organ. In this example, the organ is based on an image of an existing organ.

The patient 417 is missing a kidney, but still has one kidney 418 intact and healthy. That kidney is imaged 419 and the data is sent to the server 420, where a virtual model 421 of the organ is automatically generated. This model is used to create an entirely new model 422. In its simplest form, the model for the new kidney is generated simply by mirroring the existing kidney, but in reality additional steps may be applied to make subtle changes to the organ model that reflect natural differences between left and right organs in the body.

Once the new kidney model 422 is inspected it is sent to be manufactured. The manufacturing methods can vary. In some cases a cell printer 423 may directly manufacture the replacement organ. In other cases, a bioscaffold may be assembled from the model data and used to grow a new organ in vitro. In other cases, the model may be used to create a mold in which tissue is cultured.

Once the new organ 424 has been produced it inspected and then carefully shipped to the hospital and implanted in the patient. Typically the organ would be grown with material harvested from the original organ, so there is little chance of rejection or complications due to bio-incompatibility.

The same technique could be applied to a wide variety of organs and tissues. Additionally the technique could be applied to the manufacture of prostheses, where a scan of one limb is used to generate a symmetric model of the missing limb. That model can then be used to design a functional prosthetic that exactly matches the physiology of the patent.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure such that structural and logical substitutions and changes may be made without departing from the scope of the disclosure. For example, method steps may be limited to performed in a different order than is shown in the figures or one or more method steps may be omitted. Accordingly, the disclosure and the figures are to be regarded as illustrative rather than restrictive.

Moreover although specific embodiments have been illustrated and described herein it should be appreciated that any subsequent arrangement designed to achieve the same or similar results may be substituted for the specific embodiments shown. This disclosure is intended to cover any and all subsequent adaptations or variations of various embodiments. Combinations of the above embodiments and other embodiments not specifically described herein will apparent to those of skill in the art upon reviewing the description.

In the foregoing Detailed Description various features may be grouped together or described in an embodiment for the purpose of streamlining the disclosure. This disclosure is not to be interpreted as reflecting an intention that the claimed embodiments requiring more features are expressly recited in each claim. Rather as the claims reflect the claimed subject matter they may be directed at less than all of the features of any of the disclosed embodiments.

1. An apparatus for creating products from data comprising:
A processor;
software installed in the processor, the software automatically generates a manufacturing model;
an interface integrated with the software, wherein the interface allows a user to input data; and
manufacturing equipment, wherein the manufacturing equipment produces a requested product.

2. The apparatus for creating products from data of claim 1, including an interface for inspection, pricing, ordering and shipping information.

3. The apparatus for creating products from data of claim 1, wherein said user interface is network based and accesses a remote manufacturing facility.

4. The apparatus for creating products from data of claim 1, wherein said user interface is a stand-alone processor contain the software working locally to access a remote manufacturing equipment.

5. The apparatus for creating products from data of claim 1, wherein said manufacturing equipment is co-located with the processor.

6. The apparatus for creating products from data of claim 1, wherein the final product is a manufacturable computer model.

7. The apparatus for creating products from data of claim 1, wherein the user interface is a hybrid of standalone and internet based software and hardware.

8. The apparatus for creating products from data of claim 1, wherein the user creates an entirely new product derived from the information in the data, that new product not being represented in the original data.

9. The apparatus for creating products from data of claim 1, wherein the user creates a new product derived from the data, that new product being a hybrid of a new design derived from the data and an object described in the data.

10. The apparatus for creating products from data of claim 1, wherein the software incorporates machine learning algorithms to automatically create a product from input data based on past user behavior.

11. The apparatus for creating products from data of claim 1, wherein the software uses machine learning to automatically design products based on similarities to other user data.

12. The apparatus for creating products from data of claim 1, wherein the software automatically appends information or designs to the product using features, color and texture.

13. The apparatus for creating products from data of claim 1, including an interface that allows the user to select and preview different manufacturing methods and materials.

14. The apparatus for creating products from data of claim 1, including an interface where the user can change the properties of appended features, color and texture information or designs of the product.

15. The apparatus for creating products from data of claim 1, including software that simulates usage of the product to validate functionality before it is manufactured.

16. A system for creating products from data comprising:
a processing means;
software installed on the processing means that creates a manufacturing model;
an interfacing means that allows the user to pick, inspect and change the manufacturing model;
and,
a manufacturing means.

17. The system for creating products from imaging data of claim 16, wherein said interfacing means allows multiple users to collaborate.

18. A method for creating products from data comprising the steps of:
a. a step of providing an interface for a user to input data;
b. a step of automatically creating a manufacturing model from this data.

19. The method for creating products from data of claim 18, including the following steps;
a. a step of automatically validating that this model can be created;
b. a step of automatically suggesting optimal manufacturing techniques for the model;
c. a step of automatically generating a cost of manufacturing using the selected technique; and
d. a step of providing an interface for the user to order the product based on the model.

20. The method for creating products from data of claim 18, including the following steps;
a. a step of using machine learning algorithms to automatically select regions of the data based on past user selections;
b. a step of using machine learning to automatically select features based on similarities to other user data;
c. a step of using machine learning to suggest selections;
d. a step of automatically appending features, color and texture to the model;
e. A step of letting the user change the added features, color, and texture;
f. a step of automatically validating that the model can be created;
g. a step of automatically suggesting optimal manufacturing techniques for the model;
h. a step of automatically generating a cost of manufacturing using the selected technique;
i. a step of providing an interface for the user to order the product based on the model; and,
j. A step for distributing orders to different manufacturing equipment to optimize delivery time.
